(19) United States
(12) Patent Application Publication
(10) Pub. No.: US 2019/0278836 A1
(43) Pub. Date: Sep. 12, 2019

(54) ASSISTED REVIEW CREATION

(71) Applicant: GOOGLE LLC, Mountain View, CA (US)

(72) Inventors: Kevin Snow McCurley, San Jose, CA (US); Dandapanai J. Sivakumar, Cupertino, CA (US); Prabhakar Raghavan, Saratoga, CA (US)

(21) Appl. No.: 16/422,930

(22) Filed: May 24, 2019

Related U.S. Application Data
(63) Continuation of application No. 13/908,755, filed on Jun. 3, 2013.

(51) Int. Cl. G06F 17/24

(52) U.S. Cl. CPC G06F 17/243

(57) ABSTRACT

Review creation. Identifying at least one reviewable object from user-generated content. Prompting a user associated with the user-generated content to select a reviewable object for review. Receiving, in response to the prompting, selection of a prompted reviewable object. Presenting a review template to the user for review of the selected reviewable object. Receiving input to the review template. Storing the received input as a review of the reviewable object.

### FIELD OF THE TECHNOLOGY

The disclosed technology relates to creation of online reviews generally. Example embodiments of the technology relate to assistance in identifying reviewable objects, and presenting a structured template for completion by a user.

### BACKGROUND

A typical online review of a product, a service, an entity, or anything that a person may have an opinion about (hereinafter a “reviewable object”) may include unstructured and structured components. The unstructured components of the review may include one or more of text and media; while structured components of the review may include numerical/categorical ratings along various review dimensions such as “ease of use,” “reliability,” and “portability.”

Increasingly, across all types of web sites, content created by users of the site is proliferating. For example, the substantial majority of content published via social networking services is user generated content (UGC). It is typical for this UGC to include a reference to a potential reviewable object. While such a reference, in and of itself, typically is not sufficient to serve as a formal review, that is, a review that can be combined with other reviews to form an aggregate accurately representative of a population of users, such UGC can signal an association between the user and the review object. Further, such UGC can express a sentiment regarding the review object.

### BRIEF DESCRIPTION OF THE DRAWINGS

FIG. 1 is a diagram of an architecture for example embodiments of the technology disclosed herein.

FIG. 2 is a diagram depicting method for assisted review creation, in accordance with certain example embodiments.

FIG. 3 is a diagram depicting method for assisted review creation, in accordance with certain example embodiments.

FIG. 4 is a diagram depicting method for assisted review creation, in accordance with certain example embodiments.

FIG. 5 is a diagram depicting method for assisted review creation, in accordance with certain example embodiments.

FIG. 6 is a block diagram depicting a computing machine and a module, in accordance with certain example embodiments.

### SUMMARY

The technology includes methods, computer program products, and systems for assisted review creation. In such methods, at least one reviewable object can be identified from user-generated content. A user associated with the user-generated content can be prompted to select a reviewable object for review. Embodiments of the technology can receive selection of a prompted reviewable object. A review template can be presented to the user for review of the selected reviewable object. Embodiments of the technology can receive input to the review template, and can store the received input as a review of the reviewable object.

In some embodiments, identifying can include one or more of: parsing the user-generated content for one or more references to reviewable objects from a reviewable object taxonomy; applying natural language processing to the user-generated content; querying a reference system with a subset of the user-generated content, receiving a response to the query from the reference system, and identifying one or more reviewable objects from the response; identifying one or more reviewable objects from metadata associated with the user-generated content; and identifying one or more reviewable objects from the target of a link included in the user-generated content.

In some embodiments of the technology, input can be requested from the user confirming at least one identified reviewable object. Input confirming at least one reviewable object can be received, and the user can be prompted to select a confirmed reviewable object for review.

In some embodiments of the technology, identifying include identifying a plurality of reviewable object from user-generated content. In such embodiments, prior to prompting a user associated with the user-generated content to select a reviewable object for review, the review objects can be prioritized. In such embodiments, prompting a user associated with the user-generated content to select a reviewable object for review further includes prompting with reviewable objects in the order of prioritization.

In some embodiments, identifying a reviewable object includes identifying at least one sentiment included in the user-generated content; the sentiment being associated with the at least one identified reviewable object. In such embodiments, presenting a review template includes presenting the identified sentiment in the review template.

### DETAILED DESCRIPTION

An increasing amount of commerce is being influenced by reviews, but users often may be unmotivated to create a review, and the process of creating a review may be onerous—even to a motivated user. Further, highly motivated reviewers may be more likely to review those items for which the reviewer has strong feelings—leaving the middle of the review distribution uncharacterized. Lowering the transaction cost of creating reviews may facilitate greater coverage of reviews across review objects, an increase in the number of reviews for moderately rated review objects, and higher quality reviews.

Embodiments of the present technology, can leverage UGC to identify candidate review objects, present the user with a template for creating a review, receive input from the user, and store the review as a review of the object.

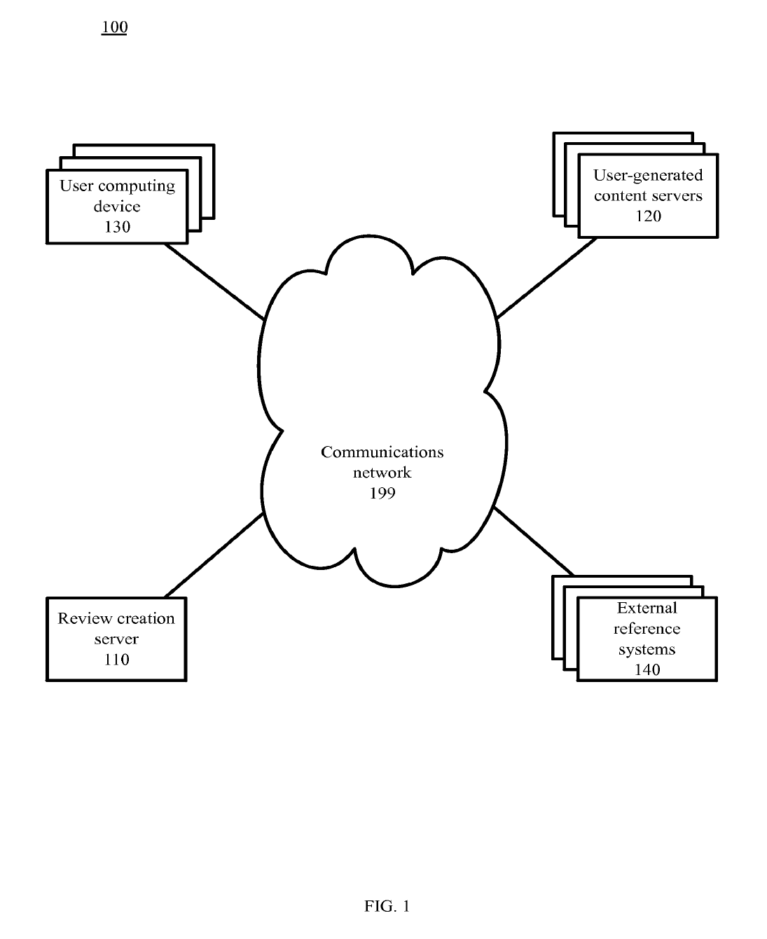

Turning now to the drawings, in which like numerals represent like (but not necessarily identical) elements throughout the figures, example embodiments of the present technology are described in detail. FIG. 1 is a diagram of an architecture 100 for example embodiments of the technology disclosed herein. As depicted in FIG. 1, the architecture 100 includes network devices 110, 120, 130, and 140; each of which may be configured to communicate with one another via communications network 199.

Network 199 includes one or more wired or wireless telecommunications means by which network devices may exchange data. For example, the network 199 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a Bluetooth connection, a near field communication (NFC) connection, any combination thereof, and any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device can include a communication module capable of transmitting and receiving data over the network 199. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device. In the example embodiment depicted in FIG. 1, the network devices 110, 120, 130, and 140 may be operated by an entity practicing embodiments of the present technology, an entity operating a source of UGC (such as a social network or a review website), a consumer/potential reviewer, and an entity operating a search engine respectively.

The network connections shown are example and other means of establishing a communications link between the computers and devices can be used. Moreover, those having ordinary skill in the art having the benefit of the present disclosure will appreciate that the network devices illustrated in FIG. 1 may have any of several other suitable computer system configurations. For example, a user device 130 embodied as a mobile phone or handheld computer may not include all the components described above.

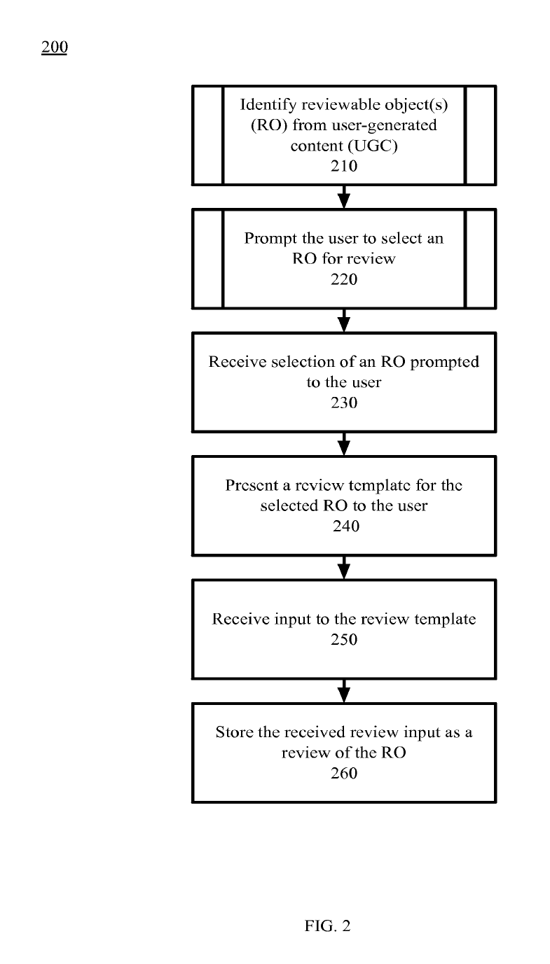

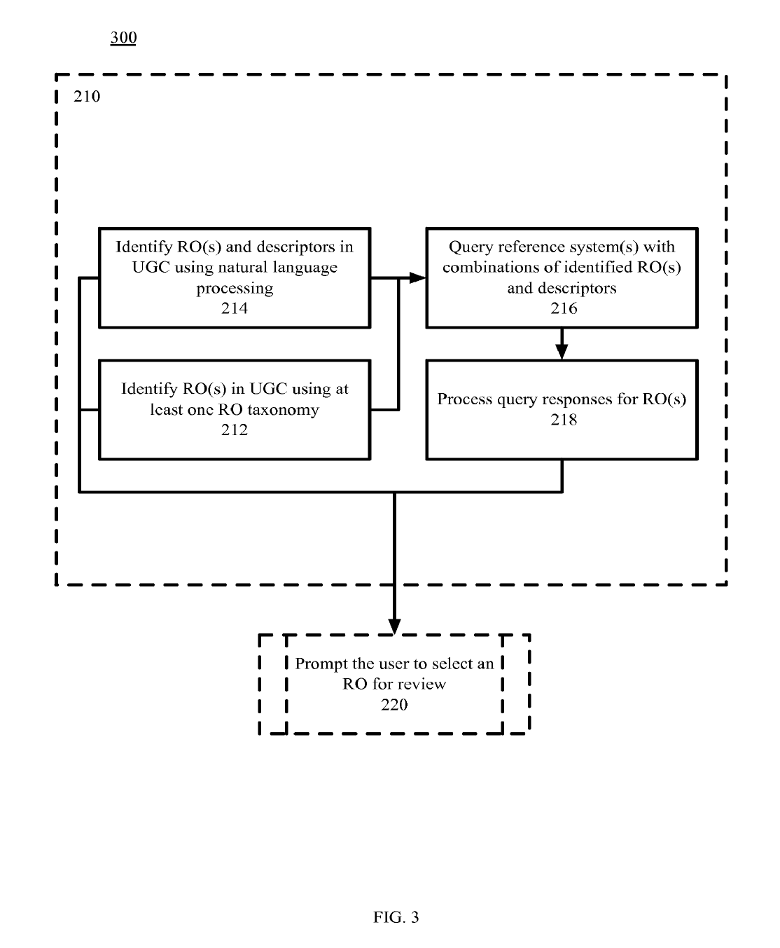

Referring to FIG. 2, and continuing to refer to FIG. 1 for context, methods 200 of the present technology are illustrated. In such methods, the technology can identify reviewable objects from UGC—Block 210. Referring to FIG. 3, further illustrating methods 300 of the technology, some embodiments of the technology can use taxonomy of review objects, such as typically maintained by online review aggregators or online shopping services, to match UGC to reviewable objects—Block 212. Natural language processing (NLP) techniques such as named entity recognition, co-reference resolution, relationship extraction, and sentiment analysis can be used to identify candidate entities—Block 214. External reference systems 140 can be queried using queries formed from UGC—Block 216. The results received in response to the query can be processed for reviewable objects, for example, by using the NLP, taxonomies, and other methods described in connection with Block 210—Block 218.

Metadata that accompanies UCG, such as the Exchangeable image file (Exif) format data that can be used to specify digital camera settings, date and time of digital image included in UGC, also can be used by the technology to identify candidate reviewable objects from UGC. Other such formats, for example extensible media platform (XMP), include the name of an identified face, the name of a city where the image was taken, the name of an event, altitude, keywords, photographer annotations from speech recognition, etc. Image recognition can be used to identify candidate reviewable objects. Links contained in the UCG can be analyzed, and a link can be followed to identify candidate reviewable objects from the link target. Speech recognition also can be applied to an audio track in video to extract text as metadata. Each of the approaches disclosed above can be used to identify people, places, and things associated with candidate reviewable objects, and to increase the confidence in candidate identifications.

For example, consider a social network posting today of a user-generated photo of a concert venue with the user-generated caption “<Entertainer name> was fabulous yesterday! And dinner nearby was just as good.” Name entity recognition can be used to identify <entertainer name> as a candidate reviewable object. Sentiment analysis can identify that the user has a favorable opinion of the entertainer based on “fabulous” and the exclamation point. Exif metadata from the image, such as GPS coordinates, and image recognition can be used to identify the venue as a candidate reviewable object. Querying an external reference with <entertainer name>, the date from the metadata, or the date of the day before the posting (based on the temporal clue “yesterday”) can return the identity of both the venue and the opening act—which can each be identified as candidate reviewable objects by applying name recognition to the results. Image recognition can be performed on the photo to identify restaurants in the photo as candidate reviewable objects based on “dinner nearby.”

In situations in which the technology discussed here collects personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Further, a user may choose to allow personal information to be used for the benefit of other users associated with the user, for example, friends of the user in a social graph. For example, if a user's friend is identified in a calendar event for a dinner reservation with the user, then the user may allow this information to be used to prompt the friend to review the restaurant identified in the invitation. Such functionality would be subject to the conditions placed by the friend on the use of the friend's information.

Knowledge about the user also can be used to prioritize candidate reviewable objects for review. For example, if the technology is aware of user-supplied preferences, for example, vegan restaurants, then vegan restaurants can be prioritized as reviewable objects. As another example, if the user has previously searched for a particular restaurant, then that restaurant can be prioritized as a reviewable object—even if the technology has no indication that the user has ever visited the restaurant.

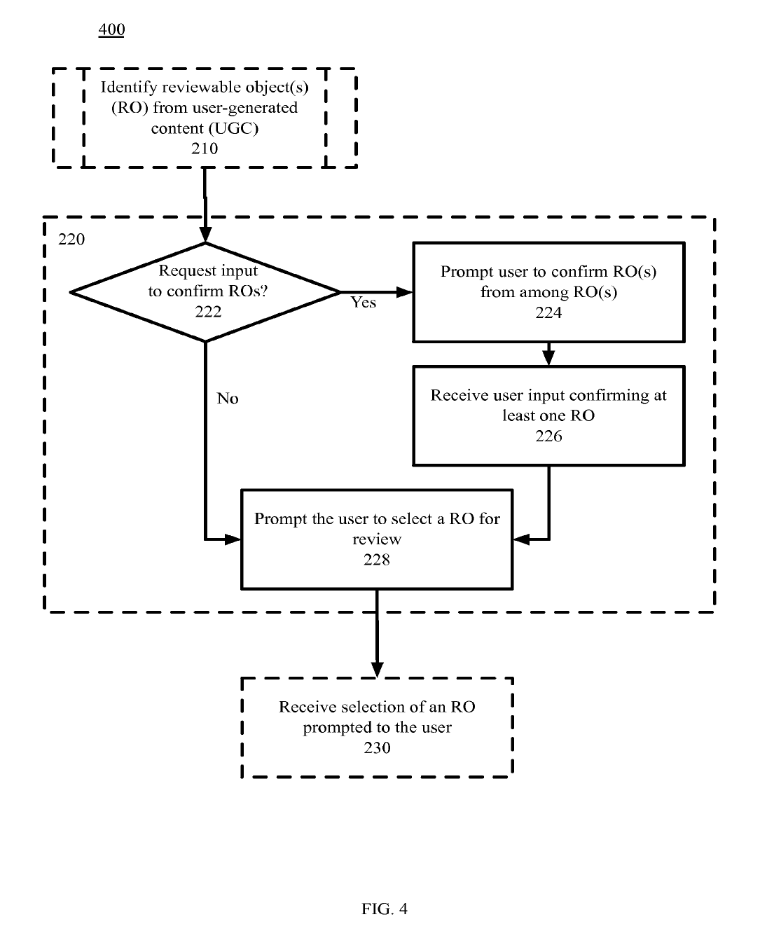

Referring again to FIG. 2, embodiments of the technology can prompt the user to select an RO for review—Block 220. Referring to FIG. 4, further illustrating methods 400 of the technology, confirmation that the user considers the candidate reviewable object a reviewable object (RO) can be solicited—Block 222. In embodiments where the technology solicits such confirmation a user can be prompted to confirm one or more ROs from among one or more candidate ROs—Block 224.

User input, for example via user computing device 130, can be received confirming at least one RO—Block 226. Upon receiving a selection or confirmation of a candidate reviewable object, embodiments of the technology can present a review template to the user via a user computing device—Block 228. The review template can include dimensions of rating that are applicable to the type of object, a free-text field, and fields for further characterization of the review object. One or more of these dimensions and the free text field can be pre-set/populated with information, for example sentiment, discerned from the user's UCG. The review template can include comparison questions. Continuing the example from above, the technology can present the venue, the entertainer, and a set of restaurants in the vicinity of the venue for confirmation of the items as ROs, and subsequent review of the confirmed ROs.

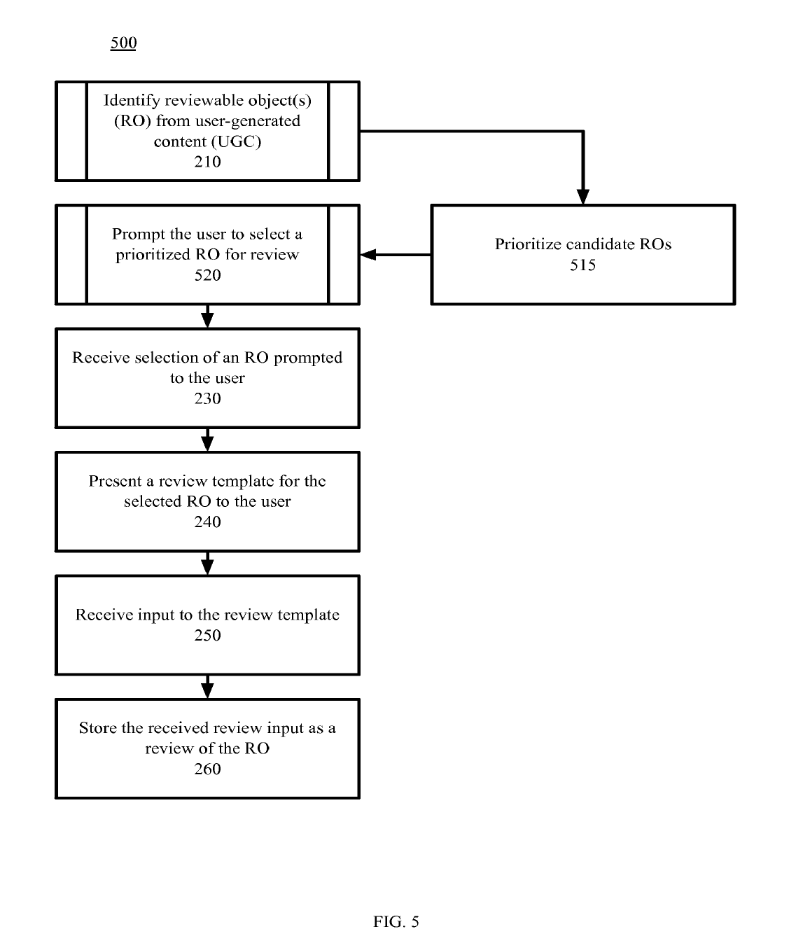

Referring to FIG. 5, the candidate reviewable objects can be prioritized—Block 515. Prioritization can be by a variety of factors including the number of reviews currently available (a candidate reviewable object with a lower number of reviews, or a lower proportion of reviews compared to the average number of reviews for objects of that type, can be prioritized over a candidate reviewable object with a higher number or proportion), the degree of sentiment express in the UCG with regard to the reviewable object (a greater willingness to complete a review can be inferred from stronger sentiment). The user can be promoted to review ROs from the list of prioritized ROs—Block 520. Continuing the example from above, while many reviews of the entertainer may be available (the majority of reviewers think that the entertainer is fabulous), there may be a need for more reviews of the venue. There may be ten (10) restaurants serving dinner “nearby” the venue. Under such circumstances, embodiments of the technology can prioritize the venue as the top priority for review, the entertainer second; and then a list of ten (10) nearby restaurants.

Referring again to FIG. 2, a subset of the candidate reviewable objects can be presented to a user through a user device—Block 230. After receiving selection of the venue as a reviewable object, embodiments of the technology can present a review template for the selected RO—Block 240. Continuing with the present example, the technology can present the user with a series of slider bars for review dimensions associated with venues, such as “ease of parking,” “quality of sound,” and “friendliness of staff” The technology can present a “star rating” selection, and a free form text field pre-populated with “<Entertainer name> was fabulous yesterday! And dinner nearby was just as good.” Embodiments of the technology can present comparison questions such as “Did you enjoy <venue> as much as you enjoyed <a previous venue rated by the user>?”

The technology can receive input to the review template—Block 250. For example, a user may use the user computing device 130 to position the slider bars to reflect the user's impression of the venue, selected a certain number of stars, and edit the free text extracted from the UGC. The received input can be stored as a structured review of the RO.

In some embodiments, the technology can use aggregated UGC across a plurality of uniform resource locators (URLs). In other words, multiple posts might be made to identify an ongoing activity (for example, salsa dancing mentioned in two posts, combined with geolocation from a photo taken the day of the multiple posts).

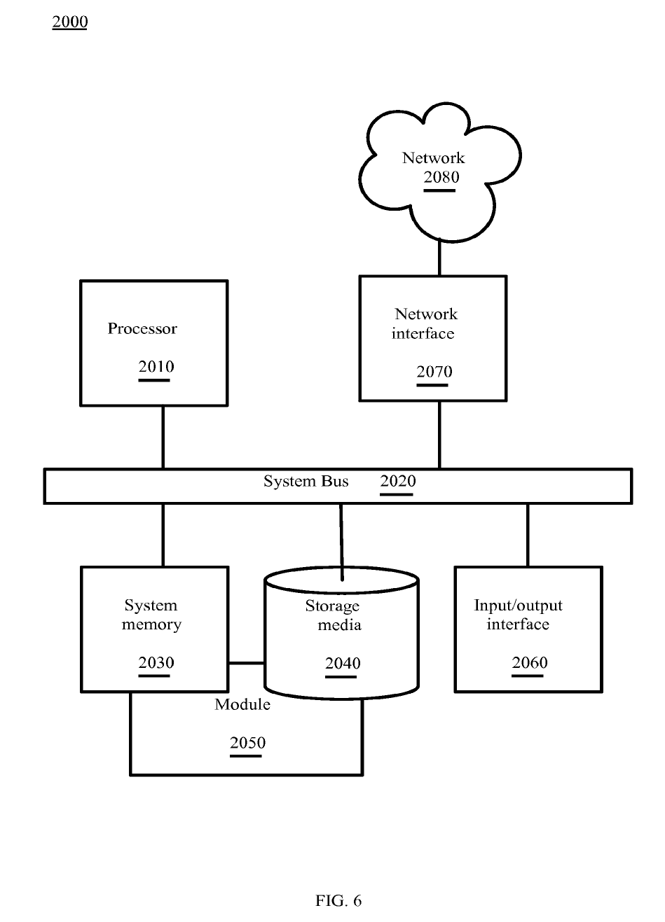

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (ROM), programmable read-only memory (PROM), erasable programmable read-only memory (EPROM), flash memory, or any other device capable of storing program instructions or data with or without applied power. The system memory 2030 may also include volatile memories such as random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid sate drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (SCSI), serial-attached SCSI (SAS), fiber channel, peripheral component interconnect (PCT), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (SOC), system on package (SOP), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the technology described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1-18. (canceled)

19. A system to enable users to receive input to characterize reviewable objects identified from user-generated content, comprising:
a storage device;
a network device; and
a processor communicatively coupled to the storage device and the network device, wherein the processor executes application code instructions that are stored in the storage device to cause the system to:
receive user-generated content from a user computing device associated with a user, the user-generated content comprising text entered via the user computing device;
identify one or more terms in the received text;
identify one or more reviewable objects from the one or more identified terms;
transmit, to the user computing device, a request to select a reviewable object for review from the one or more identified reviewable objects;
receive, from the user computing device, an indication of a selection by the user of a particular reviewable object from the one or more reviewable objects;
transmit, to the user computing device and for display via the user computing device, a request for input characterizing the particular reviewable object; and
receive, from the user computing device, input characterizing the particular reviewable object.

20. The system of claim 19, wherein the one or more reviewable objects are identified from the one or more identified terms based on a search history of the user.

21. The system of claim 19, wherein identifying the one or more reviewable objects from the user-generated content comprises at least one of:
parsing the user-generated content for one or more references to reviewable objects from a reviewable object taxonomy;
applying natural language processing to the user-generated content;
querying a reference system with a subset of the user-generated content, receiving a response to the query from the reference system, and identifying one or more reviewable objects from the response; and
identifying one or more reviewable objects from metadata associated with the user-generated content.

22. The system of claim 19, wherein transmitting the request to select the reviewable object further comprises:
transmitting, to the user computing device, the prompt instructing the user to select a reviewable object for review.

23. The system of claim 22, wherein the processor further executes application code instructions that are stored in the storage device and that cause the system to prioritize the review objects in an order of prioritization prior to prompting a user associated with the user-generated content to select a reviewable object for review, wherein prompting the user associated with the user-generated content to select a reviewable object for review further comprises prompting with reviewable objects in the order of prioritization.

24. The system of claim 19, wherein:
identifying at least one reviewable object further comprises identifying at least one sentiment included in the user-generated content, the sentiment associated with one or more of the one or more identified reviewable objects; and
transmitting the request for input characterizing the particular reviewable object comprises transmitting a review template to the user computing device for presentation via the user computing device, the review template comprising the identified sentiment.

25. The system of claim 19, wherein the user-generated content further comprises content across a plurality of uniform resource locations.

26. The system of claim 19, wherein the user-generated content further comprises one or more of image and video content captured via the user computing device.

27. A computer-implemented method to receive input to characterize reviewable objects identified from user-generated content, comprising:
by one or more computing devices:
receiving user-generated content from a user computing device associated with a user, the user-generated content comprising text entered via the user computing device;
identifying one or more terms in the received text;
identifying one or more reviewable objects from the one or more identified terms based at least in part on a search history associated with the user;
transmitting, to the user computing device, a request to select a reviewable object for review from the one or more identified reviewable objects;
receiving, from the user computing device, an indication of a selection by the user of a particular reviewable object from the one or more reviewable objects;
transmitting, to the user computing device and for display via the user computing device, a request for input characterizing the particular reviewable object; and
receiving, from the user computing device, input characterizing the particular reviewable object.

28. The computer-implemented method of claim 27, wherein identifying the one or more reviewable objects from the user-generated content comprises at least one of:
parsing the user-generated content for one or more references to reviewable objects from a reviewable object taxonomy;
applying natural language processing to the user-generated content;
querying a reference system with a subset of the user-generated content, receiving a response to the query from the reference system, and identifying one or more reviewable objects from the response; and
identifying one or more reviewable objects from metadata associated with the user-generated content.

29. The computer-implemented method of claim 27, wherein transmitting the request to select the reviewable object further comprises:
transmitting, to the user computing device, the prompt instructing the user to select a reviewable object for review.

30. The computer-implemented method of claim 29, further comprising prioritizing, by the one or more computing devices, the review objects in an order of prioritization prior to prompting a user associated with the user-generated content to select a reviewable object for review, wherein prompting the user associated with the user-generated content to select a reviewable object for review further comprises prompting with reviewable objects in the order of prioritization.

31. The computer-implemented method of claim 27, wherein:
identifying at least one reviewable object further comprises identifying at least one sentiment included in the user-generated content, the sentiment associated with one or more of the one or more identified reviewable objects; and
transmitting the request for input characterizing the particular reviewable object comprises transmitting a review template to the user computing device for presentation via the user computing device, the review template comprising the identified sentiment.

32. The computer-implemented method of claim 27, wherein the user-generated content further comprises content across a plurality of uniform resource locations.

33. The computer-implemented method of claim 27, wherein the user-generated content further comprises one or more of image and video content captured via the user computing device.

34. A computer program product to receive input to characterize reviewable objects identified from user-generated content, comprising:
a non-transitory computer-readable storage device having computer-executable program instructions embodied thereon that when executed by a computer cause the computer to:
receive user-generated content from a user computing device associated with a user, the user-generated content comprising text entered via the user computing device;
identify one or more terms in the received text;
identify one or more reviewable objects from the one or more identified terms based at least in part on a search history associated with the user;
transmit, to the user computing device, a request to select a reviewable object for review from the one or more identified reviewable objects;
receive, from the user computing device, an indication of a selection by the user of a particular reviewable object from the one or more reviewable objects;
transmit, to the user computing device and for display via the user computing device, a request for input characterizing the particular reviewable object; and
receive, from the user computing device, input characterizing the particular reviewable object.

35. The computer program product of claim 34, wherein identifying the one or more reviewable objects from the user-generated content comprises at least one of:
parsing the user-generated content for one or more references to reviewable objects from a reviewable object taxonomy;
applying natural language processing to the user-generated content;
querying a reference system with a subset of the user-generated content, receiving a response to the query from the reference system, and identifying one or more reviewable objects from the response; and
identifying one or more reviewable objects from metadata associated with the user-generated content.

36. The computer program product of claim 34, wherein transmitting the request to select the reviewable object further comprises:
transmitting, to the user computing device, the prompt instructing the user to select a reviewable object for review.

37. The computer program product of claim 34, wherein:
identifying at least one reviewable object further comprises identifying at least one sentiment included in the user-generated content, the sentiment associated with one or more of the one or more identified reviewable objects; and
transmitting the request for input characterizing the particular reviewable object comprises transmitting a review template to the user computing device for presentation via the user computing device, the review template comprising the identified sentiment.

38. The computer program product of claim 34, wherein the user-generated content further comprises one or more of image and video content captured via the user computing device.
